(19) United States
(12) Patent Application Publication
(10) Pub. No.: US 2023/0357994 A1
(43) Pub. Date: Nov. 9, 2023

(54) REINFORCED FLEXIBLE POLYMER MATERIAL STRIP, METHOD OF MANUFACTURING SAME AND THREE DIMENSIONAL STRUCTURE MADE USING SAME

(71) Applicant: Mikhail AZARKH, Shoresh (IL)

(72) Inventors: Mikhail AZARKH, Shoresh (IL); Vladislav Gennadievich CHEREVATIY, Lipetskaya obl., g. Lipetsk (RU)

(21) Appl. No.: 18/028,557

(22) PCT Filed: May 13, 2022
(86) PCT No.: PCT/RU2022/050152

§ 371 Date: Mar. 26, 2023

(30) Foreign Application Priority Data
May 21, 2021 (RU) 2021114447

(51) Int. Cl. E01C 3/04; B29D 7/01

(52) U.S. Cl. CPC E01C 3/04; B29D 7/01

(57) ABSTRACT

The flexible strip of a polymeric material includes reinforcing elements and protrusions located on a surface of the strip. The reinforcing elements are placed to contact the surface of the strip and embedded at intersections between the protrusions and the reinforcing elements. A method for producing the flexible strip of a polymeric material includes extruding the polymeric material for producing a flat preform, laying the reinforcing elements onto a preform surface, processing the preform in rolls for forming protrusions on the preform surface, cutting the preform into strips. In the step of processing the preform, the reinforcing elements are embedded into said protrusions at the intersections between the protrusions and the reinforcing elements.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The invention relates to the field of construction, namely to production of three-dimensional cellular structures, e.g. geocells or spatial polymeric geogrids used for reinforcing geotechnical structures and strengthening loosened foundations of industrial and civil structures, slopes of coastlines and beds of water reservoirs, during construction of airfields, road bases, slopes, retaining walls. The strip may be applicable in other sectors of the construction industry, where increased and stable durability and service life characteristics of buildings and structures are required.

### 2. Description of Related Art Including Information Disclosed Under 37 CFR 1.97 and 37 CFR 1.98.

Various variants of producing a polymeric strip or band comprising reinforcing elements and intended for use in construction technologies are known in the art. For example, patent U.S. Pat. No. 8,182,177, IPC: E02D29/02, publ. on 22 May 2012, describes a reinforced stabilizing strip intended for use in earth structures. This reinforced stabilizing strip comprises, along at least part of its length, a reinforcing element in the form of a cord arranged longitudinally inside that part. Here, it should be noted that this source discloses a reinforced strip that is not flexible (bendable easily), and, therefore, cannot be used for producing three-dimensional cellular structures of geocell type. This strip is applicable in flat structures. Moreover, when producing this strip, it is envisaged to introduce a reinforcing cord into a passage that is preliminarily made in the strip body in the longitudinal direction. The operations of making a special passage for each reinforcing element, placing and fixing the reinforcing element in the passage are very laborious, which greatly complicates the production technology.

Korean patent KR101079004, IPC: DO3D11/00; E02D17/20; E02D29/02, publ. on 1 Nov. 2011, describes a polymeric strip reinforced with a fiber aggregate, a method for producing thereof and a flat geogrid made with the use thereof. The invention is aimed at minimizing reduction of mechanical properties due to positioning a foamed polymer into a matrix strip with controlled size and amount of fine pores in the foam.

The polymeric strip comprises a longitudinally arranged bundles of fibers positioned in a thermoplastic polymer matrix. The matrix strip is a foamed polymer comprising a plurality of fine pores having an average diameter of 0.1 to 60 μm. Porosity of the strip matrix is 10 to 70%. The total cross sectional area of the bundle of fibers is from 10 to 80% of the total cross sectional area of the reinforced polymeric strip. This strip is not intended to be used in three-dimensional cellular structures of geocell type.

Korean patent KR102073975, IPC: E02D29/02; E02D3/00, publ. on 6 Feb. 2020, describes a method for producing a strip from a foamed thermoplastic polymer reinforced with fiber bundles. The strip is used during the construction of retaining walls.

A cavity is formed in the central section in the longitudinal direction of the matrix polymeric material. The strip of this invention is made of a material that is lightweight and flexible, and perforation is provided in the strip material for to provide for drainage properties of the strip. The strip material surface has a relief with longitudinal protrusions along its whole length, and reinforcing fiber assemblies are arranged under the relief protrusions. The strip is not used for producing geocells.

An information geotechnical flexible reinforced strip for the manufacture of flat geogrid is described in Chinese utility model patent CN212248182 (U), IPC: E01C3/04, E02D3/00, GO1D21/02, publ. on 29 Dec. 2020. This strip contains a flexible plastic matrix, optical fiber and steel wire for reinforcement. A flat geogrid is formed from longitudinal strips and transverse strips by weaving and is used during the construction of retaining walls. The strip is not used for producing geocells.

Patent U.S. Pat. No. 7,993,080, IPC: E02D17/18, publ. on 9 Aug. 2011, discloses a three-dimensional cellular structure intended for production of an earthquake resistant earth retention system using geocells. The geocells are produced with the use of flexible strips of a fiber-reinforced thermoplastic polymer, an alloy or blend of polyolefin and engineering thermoplastics, such as multilayer PE-polyamide or PE-polyester. The material of the geocells may have a tensile elastic modulus at a strain rate of 10% per minute of at least 0.8 GPa, a tensile strength at a strain rate of 10% per minute of at least 10 MPa, and creep deformation of at most 20% when loaded at 50% of its yield stress for 500 hours at 23° C. This polymeric material is suitable for producing strips for geocells.

An example is given in the description of this invention, wherein HDPE having the density of 0.941 g/cm3 was melt kneaded by a single-screw extruder at 260° C. and extruded through a flat die, wherein glass fiber rowing was fed to the melt to provide a continuous fiber-reinforced composite strip. The weight percentage of fibers in the polymer was set to 15% of the strip weight. The melt was calendared to form an embossed strip having average thickness of 1.2 mm. Proceeding from the fact that reinforcing elements in the form of glass fiber were fed to the polymer melt, the continuous fiber-reinforced composite strip was produced, wherein glass fiber is located inside the strip polymer matrix; hence, at high lateral loads the thin strip (1.2 mm) may be cut by the reinforcing elements if their diameter is compatible with the strip thickness.

Eurasian patent EA014781, IPC: B32B27/08, C08J3/20, C08K7/00, E02D17/20, publ. on 28 Feb. 2011, describes a geotechnical product and a method for producing thereof. According to the claims, a geotechnical product is provided that has at least one layer having a thermal expansion coefficient less than about 150 ppm/° C. at ambient temperature; resistance to acidic media greater than that of a polyamide resin and/or resistance to basic media greater than that of PET; resistance to hydrocarbons greater than that of HDPE; a creep modulus of at least 400 MPa at 25° C. at 20% of yield stress load for 60 minutes according to ISO 899-1 standard of the International Organization for Standardization; and 1% secant modulus of elasticity of at least 700 MPa at 25° C. according to ASTM D790 standard of the American Society for Testing Materials; wherein at least one layer consists of a composition comprising: (a) at least one polymer or oligomer in an amount from about 1 to about 94.5% of the composition weight, comprising, on the average, at least one functional group per polymer or oligomer chain selected from carboxyl, anhydride, oxirane, amine group, amide group, ester group, oxazoline, isocyanate or any combination thereof; (b) at least one engineering thermoplastic in an amount from about 5 to about 98.5% of the composition weight, (c) at least one filler in an amount from about 0.5 to about 94%; and, additionally, an unmodified polyolefin, ethylene copolymer or terpolymer in an amount of up to 93.5% of the composition weight.

As a reinforcing filler, it is proposed to use a powder, and/or monocrystalline whiskers, and/or fibers. Further, the description states that one embodiment of the geotechnical product comprises friction promoting elements on at least one outer surface of the product, where the friction promoting elements include, e.g., textures, and/or a convex relief, and/or a relief with depressions, and/or through holes, and/or finger-shaped embossments, and/or hair-like embossments, and/or wavy embossments, and/or embossed lines, and/or embossments in the form of bundled fibers or grains, or combinations thereof, and/or points, and/or braids, and/or combinations thereof.

Thus, this patent provides for the use of embossing for creating a relief surface, and the reinforcing fillers are traditionally introduced into the inner layers of the polymer matrix.

Patent U.S. Pat. No. 8,790,036, IPC: C09K17/00; E01C3/04, (PRS MEDITERRANEAN LTD [IL]), publ. on 29 Jul. 2014, describes geotechnical structures and processes for forming the same. This patent discloses geotechnical structures formed from a geosynthetic article and an encapsulated granular material dispersed within or upon the geosynthetic article. A geocell is used as the geosynthetic article in particular embodiments. Among other things, the geotechnical articles can be used for forming roads, parking lots, paved surfaces, as well as road beds and foundations for highways or railroads. The patent specification also discloses a water permeable geotechnical structure for use in slopes, channels, walls and pavements. For such applications, a combination of high hydraulic conductivity, excellent erosion resistance, and high bearing capacity is desirable. The geotechnical article contains a layer of an encapsulated granular material, which allows for porosity even when compacted. The geosynthetic article may be a geogrid, a geocell, a geofabric, chopped fibers, or a naturally fibrous material. Exemplary fibers/fibrous materials include glass fibers, jute fibers, kenaf fibers, hemp fibers, flax fibers, polyester fibers, and polyamide fibers. As described previously, the encapsulated granular material is either placed within or upon a geogrid/geocell/geofabric. In the case of chopped fibers and naturally fibrous material, the fibers are mixed with the encapsulated granular material, then compacted together to form the geotechnical structure. The fibers are arranged in a polymer matrix, but the specification to U.S. Pat. No. 8,790,036 does not contain pictures or drawings explaining fiber arrangement in a polymer strip material in more detail.

International Application WO2011045458, IPC: E01C11/16, E01C3/00, E02D17/20, publ. on 21 Apr. 2011, describes a perforated, textured or non-textured material of a cell for three-dimensional cellular protective system. The cell material, which surface is perforated, allows roots, sand, as well as pipes and cables to pass through perforated holes by interacting with the cellular material. Perforation improves drainage properties, but does not improve the possibility of fixing the cellular structure on the ground quickly.

Eurasian patent EA031743, IPC: E02D 17/20, publ. on 28 Feb. 2019, describes a load transfer device for an expanded cellular structure for confinement of a material, a cellular confinement system and a method for transferring load from an expanded cellular confinement structure. Perforated polymeric strips are used for producing the cellular structure, which, apart from round drainage openings, further comprise oval openings for a cable and a connector. The availability of oval holes improves the possibility of fastening the cellular structure to the ground quickly owing to the use of the connector.

Utility model patent RU186059, IPC: E02D 17/20, (PRESTORUS LTD [RU]), publ. on 28 Dec. 2018 describes a geogrid connector. The geogrid connector is a fastening device for quick mounting geogrids and fixing a reinforcing cable therein.

The closest prior art of the claimed invention relative to the claimed strip of a polymeric material intended for producing a three-dimensional cellular structure is a flexible polymeric strip disclosed in the specification of patent RU2474637, IPC: E01C 3/00, E02D 17/20, publ. on 10 Feb. 2013, and in claim 12 of the claims thereto. This strip is made of measured lengths of a polymeric tape comprising longitudinal reinforcing threads and is intended for the production of a spatial polymeric grid. A disadvantage of this technical solution is deep embedding of reinforcing threads into the strip polymer matrix, in particular introduction of reinforcing threads into the strip to a depth greater than a thickness of the reinforcing thread. However, taking into account the fact that, in order to attain high flexibility, the strip has a relatively small thickness, not more than 1-2 mm, the diameter of the thread used for reinforcing in this invention, which is 0.2 mm, is comparable to the thickness of the strip itself, due to which the risk of cutting the strip with the reinforcing thread during operation at high lateral loads appears.

Patent RU2625058, IPC: E02D17/20, publ. on 11 Jul. 2017, describes a method for producing a flexible reinforced strip of thermoplastic polymeric material, which is taken as the closest prior art and which comprises:
extruding a molten material for producing a polymer web,
laying reinforcing threads onto the web,
calendering the web while heating it to 120-200° C. to ensure embedding of the reinforcing threads into the web,
cutting the reinforced web into sheets,
perforating the sheets to produce drain holes,
cutting the sheets into strips,
wherein reinforcing threads are used that are made of polyester or laysan and consist of at least two fibrous elements twisted along their length, and before laying the reinforcing threads onto the web, they are impregnated;
the web is calendered for embedding the reinforcing threads to a depth of at least 0.25 mm.

A disadvantage of this method is deep embedding the reinforcing threads into the strip material, which reduces shear resistance of the strip at lateral loads.

Patent RU2625058, IPC: E02D17/20, publ. on 11 Jul. 2017, describes a three-dimensional cellular structure made in the form of a three-dimensional reinforced geogrid of flexible polymeric strips arranged in rows and connected therebetween in the staggered order along their length to form a three-dimensional cellular structure when stretched in a direction normal to their surface, the strips being provided with drain holes and reinforced longitudinally with threads, the structure being characterized in that the reinforcing threads consist of at least two fibrous elements twisted along their entire length.

A disadvantage of this technical solution is deep embedding of the reinforcing threads into the strip polymer matrix, in particular introduction of the reinforcing threads into the strip to a depth equal to the thickness of the reinforcing thread, due to which the risk of cutting the strip with the reinforcing thread at high lateral loads appears.

### BRIEF SUMMARY OF THE INVENTION

The claimed invention is aimed at overcoming the disadvantages identified in the analogous solutions known in the art.

The object of the proposed invention is to expand the range of means of reinforcing building structures and strengthening loosened foundations of industrial and civil structures, slopes of coastlines and beds of water reservoirs, which is achieved by developing high-duty three-dimensional cellular structures with improved operational reliability and stability at high lateral loads due to the use of a new structure of a flexible strip of a polymeric material, which comprises reinforcing elements on the surface of the strip that may be produced by the claimed method.

The technical effect consists in expanding the range of means for producing three-dimensional cellular structures from flexible polymeric strips characterized by high specific strength values and increased resistance to cutting the polymeric material with reinforcing elements at lateral loads.

In order to solve the stated task, the group of inventions is claimed that comprises a flexible strip of a polymeric material for producing a three-dimensional cellular structure, a method for producing said flexible strip, and a three-dimensional cellular structure made of said flexible strips.

The claimed flexible strip of a polymeric material for the production of a three-dimensional cellular structure comprises reinforcing elements and protrusions located on the surface of the strip, the reinforcing elements being arranged so as to be in contact with the surface of the strip and being embedded in the protrusions at the intersections of the protrusions and the reinforcing elements.

As reinforcing elements, a flexible strip of polymeric material may comprise synthetic fibers, as well as long threads or bundles of them. Further, the reinforcing elements for the claimed strip may be woven or non-woven textile bands, and woven or knitted nets based on polymeric materials, optical fibers, wire elements, glass fibers, glass cloth strips, bundles or threads of glass fibers, as well as mineral fibers, e.g. basalt or asbestos fibers, and threads and woven or braided elements made therefrom.

In a preferred embodiment, the claimed flexible strip is further characterized in that the protrusions located on the surface of the strip form a regular relief in the form of embossment, and the reinforcing elements are arranged on the strip longitudinally and are made in the form of reinforcing threads made of high-strength fibers, the height of the embossment protrusions, the thickness of the reinforcing thread, and the thickness of the flexible strip being preferably related therebetween by the following ratio:

0.01≤(a+c)/d≤4, where:
a—height of the embossment protrusions, a=0.01-2 mm,
c—thickness of the reinforcing thread, c=0.01-2 mm,
d—thickness of the flexible strip, d=1-2 mm.

As the reinforcing threads, the claimed flexible strip comprises threads, preferably with a fleecy surface, selected from the group consisting of laysan textured threads, cord threads, polyester threads, polyamide threads, polypropylene threads, polyethylene threads, viscose threads, polyester laysan-staple threads, or the above threads combined with composite materials. In this case, the strength of the flexible strip and its reinforcement step are related therebetween by the following ratio:

0.005≤R×(h/b)×d≤12,

where:
R—strength of the flexible strip under tension at maximum load, kN/m,
b—reinforcement step, b 0.002 m,
d—thickness of the flexible strip , d=0.001-0.002 m,
h—width of the flexible strip, h=0.05-0.3 m.

The flexible strip in a preferred embodiment of the invention is provided with oval through holes.

Additionally, the flexible strip may be provided with round through drain holes, the drain holes preferably having a diameter from 6 to 13 mm, and the total perforation area being from 3 to 25% for every 150 to 250 mm of a length of the strip.

The claimed flexible strip is additionally characterized in that it comprises high density polyethylene (HDPE), or linear low density polyethylene (LLDPE), or a mixture of high density polyethylene (HDPE) and linear low density polyethylene (LLDPE) as the polymeric material.

In another embodiment, the flexible strip may comprise polypropylene (PP) or propylene homopolymer (PP HO) or metallocene polypropylene (MPP) or random propylene copolymer (PPCP) as the polymeric material.

A method for producing a flexible strip for the production of a three-dimensional cellular structure is also claimed, wherein the strip is made of a polymeric material and comprises reinforcing elements and protrusions located on the surface of the strip. The method comprises: extruding a polymeric material to produce a preform, laying the reinforcing elements on the preform surface, processing the preform in rolls for forming the protrusions on the preform surface, cutting the preform into strips. When the preform is processed in the rolls in the step of forming the protrusions, the reinforcing elements are additionally embedded into these protrusions at the intersections of the protrusions and the reinforcing elements.

A method for producing a flexible strip for a three-dimensional cellular structure is preferably characterized in that, when a preform is processed in rolls, protrusions on the surface of the strip are formed by providing a regular relief in the form of embossment; reinforcing elements are arranged longitudinally; and reinforcing threads made from high-strength fibers, in particular twisted synthetic threads with a fleecy surface, are used as the reinforcing elements; and the following ratio of the height of the embossment protrusions, the thickness of the reinforcing threads and the thickness of the flexible strip is observed:

0.01≤(a+c)/d≤4, where:
a—height of the embossment protrusions, a=0.01-2 mm,
c—thickness of the reinforcing thread, c=0.01-2 mm,

1d—thickness of the flexible strip, d=1-2 mm.

In one embodiment of the claimed invention, when the method is carried out, before cutting the extruded preform into strips, the preform is perforated to produce oval through holes.

In another embodiment of the claimed invention, when the method is carried out, before cutting the extruded preform into strips, the preform is additionally perforated to produce round through drain holes, the drain holes being preferably made with a diameter from 6 to 13 mm, and a total perforation area being from 3 to 25% per every 150-250 mm of the length of the strip.

When the claimed method is carried out, before laying the reinforcing elements on the preform surface, the reinforcing elements may be impregnated with an adhesive formulation and/or a formulation that increases their resistance to adverse natural conditions.

Also claimed is a three-dimensional cellular structure made of flexible polymeric strips comprising reinforcing elements and protrusions located on the surface of the strip, the strips being arranged in rows connected therebetween in a staggered order along their length to form a three-dimensional cellular structure when stretched in a direction normal to their surface, the strips being provided with drain holes and reinforced longitudinally with threads, the structure being characterized in that the reinforcing threads consist of at least two fibrous elements twisted along their entire length. The reinforcing elements are placed so as to contact the surface of the strip and are embedded in the protrusions located on the surface of the strip at the intersections of the protrusions and the reinforcing elements.

In a preferred embodiment, the three-dimensional cellular structure is characterized in that the flexible polymeric strips are provided with round through drain holes arranged longitudinally in rows between the reinforcing elements, with the exception of zones where the strips are connected, the drain holes preferably having a diameter from 6 to 13 mm, and a total perforation area being from 3 to 25% per every 150-250 mm of the length of the strip.

The three-dimensional cellular structure may be provided with additional oval through holes for quick mounting with the use of a key-type fastener, the holes being located in the strip connection zones, having an elongated shape extending in the direction of the reinforcement and being located in the interval between the reinforcing elements.

In another embodiment, the three-dimensional cellular structure may be provided with oval through holes for quick mounting with the use of a key-type fastener so that the holes, which are located near the end portions of the strips, may be extended both in the transverse direction and in the longitudinal direction.

### BRIEF DESCRIPTION OF THE SEVERAL VIEWS OF THE DRAWINGS

The drawings are provided for better understanding of the claimed invention, however, it will be obvious to a person skilled in the art that the disclosed group of inventions is not limited to the embodiment shown in the drawings.

FIG. 1 shows a segment of a flexible polymeric strip, a top schematic view.

FIG. 2 shows a fragment of the flexible polymeric strip, a 3D schematic view.

FIG. 3 shows, on an enlarged scale, the fragment of the flexible polymeric strip, shown in FIG. 2 as a schematic view.

FIG. 4 shows a general schematic view of the three-dimensional cellular structure made of the flexible strips shown in FIG. 1.

### DETAILED DESCRIPTION OF THE INVENTION

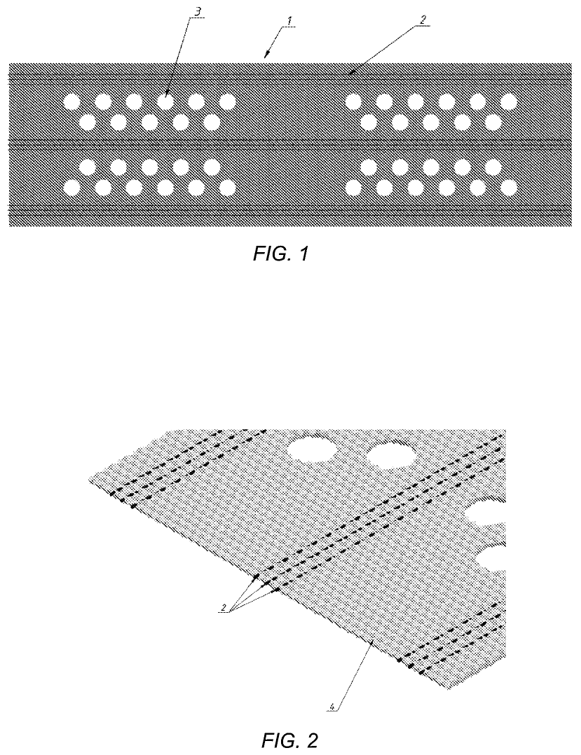

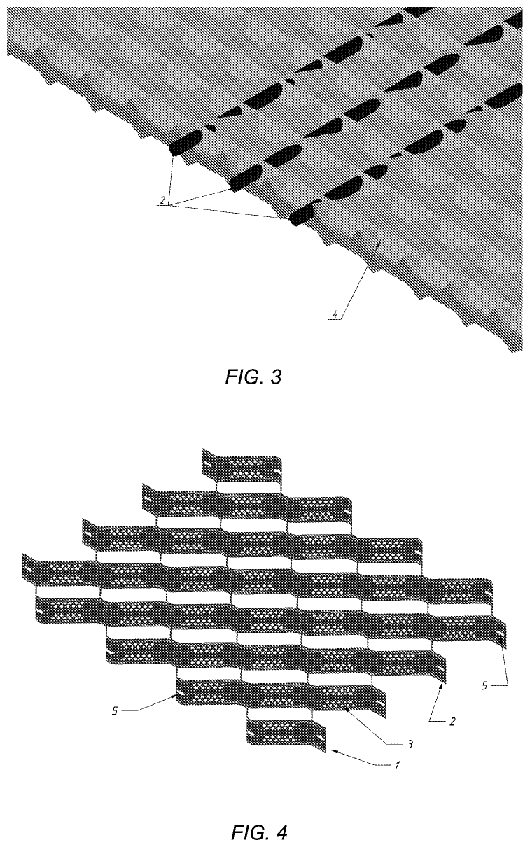

FIG. 1 shows a segment of a flexible polymeric strip 1, a top view. The flexible strip 1 comprises reinforcing elements 2 and round drain holes 3, which corresponds to one of its preferred embodiments. FIGS. 2 and 3 show on an enlarged scale that the surface of the claimed strip comprises projections 4 that form a regular relief in the form of embossment. FIGS. 2 and 3 show that the reinforcing elements 2 are placed in contact with the surface of the strip 1 and are embedded in the projections 4 at the intersections of the projections 4 and the reinforcing elements 2. Thus, the problem of limiting the reinforcing elements thickness is removed, since, being on the surface of the strip, the reinforcing elements do not reduce a critical cross-section of the strip, which is responsible for its shear strength under lateral load. The placement of reinforcing elements on the surface of the strip further improves its performance by increasing a coefficient of friction when the strip interacts with particles of soil or other filler of a three-dimensional cellular structure. The claimed invention not only provides high specific strength and cutting resistance of the strip under transverse loads, but also improves soil stabilization conditions when using the claimed strip as part of a three-dimensional cellular structure.

As shown in FIG. 1, the reinforcing elements 2 are located on the strip 1 in contact with the outer surface of the strip 1 in the longitudinal direction and, preferably, are made in the form of reinforcing threads. In this case, depending on the height of the embossment projections 4, retention of the reinforcing thread by the material of the projections 4 will change, and to provide a preset value of the operational reliability of the strip 1, the following condition must be fulfilled, according to which the height of the embossment projections 4, the thickness of the reinforcing elements 2 (reinforcing thread) and the thickness of the flexible strip 1, are related therebetween by the following ratio:

0.01≤(a+c)/d≤4, where
a—height of the embossment protrusions, a=0.01-2 mm,
c—thickness of the reinforcing thread, c=0.01-2 mm,
d—thickness of the flexible strip, d=1-2 mm.

If this ratio is observed, the preset level of operational reliability of the claimed strip and a three-dimensional cellular structure made therefrom is provided; when the strip is bent, the reinforcing elements are not pulled out from it and are firmly held in the embossment protrusions along the strip entire length.

Preferably, the claimed flexible strip comprises, as the reinforcing elements 2, threads with a fleecy surface (not shown in the drawing), since after extrusion, when processing a hot strip preform in rolls to create an embossment relief, the hairs of the reinforcing thread additionally interact with the softened polymeric material of the preform, which results in an increase in the strength of adhesion of the reinforcing elements with the polymer matrix.

In a preferred embodiment, the strip 1 comprises, as the reinforcing elements 2, threads selected from the group consisting of laysan textured threads, cord threads, polyester threads, polyamide threads, polypropylene threads, polyethylene threads, viscose threads, polyester laysan-staple threads, or said threads combined with composite materials. The main advantages of the strips reinforced with threads of this group are uniformity of the thread material and increased adhesion to a polymer matrix, which simplifies the production technology due to the absence of the need to use adhesive solutions for processing the threads. Furthermore, the threads of this group are characterized by high chemical resistance, high performance characteristics at elevated operating temperatures, the ability to process the material of the threads into secondary raw materials, which helps to reduce pollution of the environment.

Further, the strength of the flexible strip 1 and its step of reinforcement in the preferred embodiment are related by the ratio that regulates the level of the strip's breaking strength safety factor:

0.005≤R×(h/b)×d≤12, where
R—strength of the flexible strip under tension at maximum load, kN/m,
b—step of reinforcement; b 0.002 m,
d—thickness of the flexible strip, d=0.001-0.002 m,
h—width of the flexible strip, h=0.05-0.3 m.

Compliance with this ratio in the production of the strip enables to predict its strength level more accurately, which enables to reliably provide a specified strength in the finished product. The strength of the flexible strip under tension at maximum load is at least R=5-40 kN/m.

In a preferred embodiment, the flexible strip 1 is provided with oval through holes 5 that are shown in FIG. 4. The main advantages of the production of the strip 1 with oval holes are an increase in drainage capacity, accelerated installation of sections of a three-dimensional cellular structure, as well as the possibility of replacing existing metal mounting clips with polymeric fasteners—key-type fasteners (abandoning expensive equipment). In addition, the provision of the holes makes a three-dimensional cellular structure composed of flexible strips lighter.

The flexible strip may be additionally provided with round through drain holes; in the claimed cellular structure, the drain holes of the strip preferably have a diameter from 6 to 13 mm, and the total perforation area is from 3 to 25% for every 150 to 250 mm of the length of the strip. A perforation area influences the drainage factor of a three-dimensional cellular structure, thus preventing moisture saturation of its filler material, which causes the risk of damaging the structure. Depending on a water flow rate, geometrical dimensions of the strip, and a perforation area, the drainage factor of a three-dimensional cellular structure changes.

The claimed flexible strip is additionally characterized in that it comprises high density polyethylene (HDPE), or linear low density polyethylene (LLDPE), or a mixture of high density polyethylene (HDPE) and linear low density polyethylene (LLDPE) as the polymeric material.

The main advantages of strips of linear low density polyethylene (LLDPE) are high chemical resistance of this polymer; high performance characteristics both at high and low temperatures; high resistance to cracking; improved puncture resistance, as well as increased resistance to damage during installation. The production of the strip 1 from this polymer ensures successful use of a three-dimensional cellular structure in the regions of the Far North.

The main advantages of strips made of a composition (mixture) of high density polyethylene (HDPE) and linear low density polyethylene (LLDPE) are high chemical resistance of a mixture of these polymers; high performance characteristics of welds both at rather high or low temperatures; high resistance to cracking, as well as increased resistance to damage during installation. The production of the strip 1 from a mixture of these polymers ensures successful use of a three-dimensional cellular structure in the regions of the Far North.

In another embodiment, the flexible strip may comprise polypropylene (PP), or propylene homopolymer (PP HO), or metallocene polypropylene (MPP), or random propylene copolymer (PPCP), or mixtures of different compositions as the polymeric material. The main advantages of strips made of polypropylene compositions are high chemical resistance; high performance characteristics at high temperatures in use; low unit elongation at elevated operating temperatures. The production of the strip 1 from compositions of the above types of polypropylene ensures successful use of a three-dimensional cellular structure in tropical countries and other places of use at high operating temperatures.

As a part of the proposed group of inventions, a method for producing a flexible strip for a three-dimensional cellular structure is claimed, wherein the strip 1 is made of a polymeric material and comprises the reinforcing elements 2 and the protrusions 4 located on the surface of the strip 1. The method comprises extrusion of a polymeric material to produce a flat preform, laying of the reinforcing elements 2 on the preform surface, processing of the preform in rolls for forming the projections 4 on the preform surface, cutting of the preform into strips. Moreover, when processing the preform in rolls in the step of forming the protrusions 4, the reinforcing elements 2 are additionally embedded therein at the intersections of the protrusions 4 and the reinforcing elements 2.

In a preferred embodiment, the method of producing the flexible strip 1 for subsequent production of a three-dimensional honeycomb structure is characterized in that, after the extrusion step, when processing the preform in rolls, e.g. in calenders, the protrusions 4 on the surface of the strip are formed by forming a regular relief in the form of embossment. Embossment in relation to the implementation of the claimed method means extrusion, by rolls, of regular relief comprising protrusions and depressions of a certain shape. For example, FIG. 2 shows, as regular relief, depressions shaped as rhombuses with partitions therebetween protruding above the surface of the strip, which are formed by embossment on the preform surface softened by heating the polymeric material. The polymer material is heated in advance for extrusion. Then, the hot preform coming from an extruder T-die, is cooled and stabilized in rolls (calenders) having the regular relief on their working surface that is imprinted on the surface of the polymeric preform with the formation of the relief having the protrusions 4.

The reinforcing elements 2 are placed longitudinally along the preform length on the surface of the preform produced in the result of extruding the polymeric material. Preferably, reinforcing threads of high-strength fibers, in particular twisted synthetic threads with a fleecy surface, are used as the reinforcing elements 2, the following ratio of a height of the embossment projections 4, a thickness of the reinforcing elements 2 in the form of threads and a thickness of the flexible strip 1 being observed:

0.01≤(a+c)/d≤4, where
a—height of the embossment protrusions, a=0.01-2 mm,
c—thickness of the reinforcing thread, c=0.01-2 mm,
d—thickness of the flexible strip, d=1-2 mm.

As explained earlier, the above condition is observed, since retention of the reinforcing thread by the material of the projections 4 depends on the height of the embossment projections 4, which value is adjusted to ensure a preset value of the operational reliability of the strip 1.

In one embodiment of the claimed invention, when the method is carried out, the preform is perforated for producing oval through holes.

In another embodiment of the claimed invention, when the method is carried out, before cutting the extruded preform into strips, the preform is additionally perforated to provide round through drain holes; preferably, the drain holes being made with a diameter from 6 to 13 mm, a total perforation area being 3 to 25% per every 150-250 mm of the length of the strip.

When carrying put the claimed method, if necessary, before laying the reinforcing elements on the preform surface, the reinforcing elements may be impregnated with an adhesive formulation and/or a formulation that increases their resistance to adverse natural effects. Since the reinforcing threads partially lie on the outer surface of the strip and are exposed to effects of natural factors, impregnation is provided for protecting them against UV-radiation, moisture and microflora.

After extrusion, processing in rolls and perforation, the reinforced preforms are welded into blocks in ultrasonic welding units, and then they are cut into bands and strips.

As a part of the proposed group of inventions, a three-dimensional cellular structure made of the flexible polymeric strips 1 comprising the reinforcing elements 2 and the protrusions 4 located on the surface of the strips 1 is claimed, wherein the strips are arranged in rows connected therebetween in a staggered order along their length to form a three-dimensional cellular structure when stretched in a direction normal to their surface. The reinforcing elements are placed so as to contact the surface of the strip and are embedded in the protrusions 4 located on the surface of the strip at the intersections of the protrusions 4 and the reinforcing elements 2.

In a preferred embodiment, the three-dimensional cellular structure is composed of geocells or is a so-called spatial geogrid, being characterized by that the flexible polymeric strips 1 included therein are provided with round through holes 3 for drainage, placed in longitudinal rows between the reinforcing elements 2, with the exception of the zones where the strips are connected; preferably, the drain holes 3 have a diameter from 6 to 13 mm, and a total perforation area is from 3 to 25% for every 150 to 250 mm of the length of the strip 1.

The three-dimensional cellular structure may be provided with additional oval through holes 5, as shown in FIG. 4, for quick mounting with the use of a key-type fastener, the holes being located in the strip connection zones, having an elongated shape extending in the direction of the reinforcement and being provided in the interval between the reinforcing elements 2.

In another embodiment, the three-dimensional cellular structure may be provided with oval through holes for quick mounting with the use of a key-type fastener so that the holes that are located near the end portions of the strips may be extended both in the transverse direction and in the longitudinal direction.

### EXAMPLE

A three-dimensional cellular structure (spatial geogrid) is produced from flexible strips of a thermoplastic polymeric material of HDPE type, in particular that based on gas-phase high density polyethylene in accordance with GOST 16338-85 in the form of a composition based on high density polyethylene with the addition of a dye, a stabilizer and other additives modifying the properties of the polymeric material of the strip according to applicable technical requirements. When producing the strip, crushed waste—internally produced regranulate—may be added into the original polymer composition.

A polymeric reinforced preform was produced by extrusion on an extrusion line; the production process included incoming control of raw materials, preparation of a polymer composition based on high density polyethylene with the addition of a dye, a stabilizer and modifying additives, feed of the polymer composition into the extruder feed box, extrusion of a polymeric preform with the use of a T-die, while ensuring the preform thickness d=0.001-0.002 m (1-2 mm).

Upon leaving the extruder, the preform was reinforced with reinforcing elements in the form of high-strength viscose threads 1 mm thick, in particular, with the use of textured cord threads with a fleecy surface. The threads were laid on the surface of the hot preform in three groups of three filaments each with a pitch of 2 mm between the threads in the group, as shown in FIG. 1. The hot preform with the reinforcing threads laid thereon was introduced into rolls—calenders with a relief surface, where the preform polymeric material was cooled and stabilized. Under pressure of the rolls, the relief was imprinted on the surface of the polymeric preform, the relief had depressions and protrusions approximately 1 mm in height, so that the reinforcing threads 1 mm thick were captured by the material of the protrusions throughout their entire thickness at the points of their mutual intersection, and after cooling, the threads were firmly held on the surface of the polymeric preform.

After cooling, the preform was perforated to form longitudinal rows of round drain holes located between the groups of reinforcing elements, as shown in FIG. 1.

After the perforation of the drain holes was complete, the preform was longitudinally cut into strips of a given width h=0.05-0.3 m (5-30 cm). Then, the strips were transversely cut along a predetermined length into strips, the strips were laid in blocks according to a predetermined number of pieces, controlled, packaged and tested for acceptance. The tensile strength of the flexible strip under maximum load was R=40 kN/m.

The economic efficiency and environmental friendliness of the production process of the claimed product is ensured by complete processing of resulting wastes and their reuse in production.

If necessary, oval holes may be additionally punched in the finished strip for a new type of geogrid connector, for example, for a key-type fastener of the “FAST-lock” type.

To prepare sections of a cellular structure from the produced strips, the reinforced strips are welded into blocks in ultrasonic welding units. The production of the product is completed by carrying out acceptance tests of each section of the three-dimensional cellular structure, followed by strapping and packing them on pallets.

The claimed invention is further advantageous in that it expands the range of means in the form of three-dimensional cellular structures, which are widely used for reinforcing building structures and strengthening weak foundations of industrial and civil facilities as well as slopes of coastlines and beds of water reservoirs.

The invention enables to produce high-quality three-dimensional cellular structures having increased strength, operational reliability and stability under transverse loads due to the use of a new design of a flexible strip of polymeric material comprising reinforcing elements located on the outer surface of the strip, which are fixed to the strip by the claimed production method. Strength of the flexible strip under tension at maximum load is at least R=5-40 kN/m, depending on a reinforcement volume.

The technical effect is achieved by producing three-dimensional cellular structures from flexible strips based on a polymeric material and comprising reinforcing elements firmly fixed on the surface of the strip in the embossment protrusions, so that the strip is characterized by high specific strength and high resistance to polymeric material cutting by reinforcing elements under transverse loads. The method for producing the strip is characterized by simplicity, reliability, economy and environmental friendliness as well as by a wide range of possibilities for optimal selection of materials for the production of a flexible strip polymer matrix and its reinforcing elements.

1. A flexible strip of polymeric material for producing a three-dimensional cellular structure, comprising:
reinforcing elements; and
protrusions located on a surface of the strip,
wherein the reinforcing elements are arranged so as to be in contact with the surface of the strip and are embedded into the protrusions at intersections between the protrusions and the reinforcing elements.

2. The flexible strip of claim 1, wherein the protrusions located on the surface of the strip form a regular relief in the form of embossment, and wherein the reinforcing elements are arranged longitudinally and are made in the form of reinforcing threads, a height of an embossment protrusion, a thickness of the reinforcing thread, and a thickness of the flexible strip being preferably related therebetween by the following ratio:
0.01≤(a+c)/d≤4, where:
a—height of the embossment protrusions, a=0.01-2 mm,
c—thickness of the reinforcing thread, c=0.01-2 mm,
d—thickness of the flexible strip, d=1-2 mm.

3. The flexible strip of claim 2, further comprising: threads, as the reinforcing threads, with a fleecy surface, selected from the group consisting of laysan textured threads, cord threads, polyester threads, polyamide threads, polypropylene threads, polyethylene threads, viscose threads, polyester laysan-staple threads, or said threads combined with composite materials.

4. The flexible strip of claim 2, wherein a strength of the flexible strip and its reinforcement step are related therebetween by the following ratio:
0.005≤R×(h/b)×d≤12,
where:
R—strength of the flexible strip under tension at maximum load, kN/m,
b—reinforcement step, b 0.002 m,
d—thickness of the flexible strip, d=0.001-0.002 m,
h—width of the flexible strip, h=0.05-0.3 m.

5. The flexible strip of claim 1, further comprising: oval through holes.

6. The flexible strip of claim 1, further comprising: round through drain holes, the drain holes having a diameter from 6 to 13 mm, and a total perforation area being from 3 to 25% for every 150 to 250 mm of a length of the strip.

7. The flexible strip of claim 1, being comprised of high density polyethylene (HDPE), or linear low density polyethylene (LLDPE), or a mixture of high density polyethylene (HDPE) and linear low density polyethylene (LLDPE) as the polymeric material.

8. The flexible strip of claim 1, being comprised of polypropylene (PP) or propylene homopolymer (PP HO) or metallocene polypropylene (MPP) or random propylene copolymer (PPCP) as the polymeric material.

9. A method for producing a flexible strip of a polymeric material for production of a three-dimensional cellular structure, wherein the strip comprises reinforcing elements and protrusions located on a surface of the strip, the method comprising the steps of:
extruding a polymeric material to produce a preform,
laying the reinforcing elements on a preform surface,
processing the preform in rolls for forming the protrusions on the preform surface, and
cutting the preform into strips,
wherein, when the preform is processed in the rolls in the step of forming the protrusions, the reinforcing elements are additionally embedded into these protrusions at intersections of the protrusions and the reinforcing elements.

10. The method of claim 9, wherein, when the preform is processed in the rolls, the protrusions on the surface of the strip are formed by providing a regular relief in the form of embossment; the reinforcing elements are arranged longitudinally; and wherein reinforcing threads made from high-strength fibers, in particular twisted synthetic threads with a fleecy surface, are used as the reinforcing elements; the following ratio of a height of embossment protrusions, a thickness of the reinforcing threads and a thickness of the flexible strip being observed:
0.01≤(a+c)/d≤4, where:
a—height of the embossment protrusions, a=0.01-2 mm,
c—thickness of the reinforcing thread, c=0.01-2 mm,
d—thickness of the flexible strip, d=1-2 mm.

11. The method of claim 9, wherein the preform is perforated to produce oval through holes.

12. The method of claim 9, wherein, before cutting into strips, the preform is perforated to produce round through drain holes, the drain holes being preferably made with a diameter from 6 to 13 mm, and a total perforation area being from 3 to 25% per every 150-250 mm of a length of the strip.

13. The method of claim 9, wherein, before laying the reinforcing elements on the preform surface, the reinforcing elements are impregnated with an adhesive formulation and/or a formulation that increases their resistance to adverse natural conditions.

14. A three-dimensional cellular structure being comprised of flexible polymeric strips, the structure comprising:
reinforcing elements; and
protrusions located on a surface of the strip, the strips being arranged in rows connected therebetween in a staggered order along their length to form a three-dimensional cellular structure when stretched in a direction normal to their surface,
wherein the reinforcing elements are placed so as to contact the surface of the strip and are embedded in the protrusions located on the surface of the strip at intersections of the protrusions and the reinforcing elements.

15. The three-dimensional cellular structure of claim 14, wherein the flexible polymeric strips are provided with round through drain holes arranged longitudinally in rows between the reinforcing elements, with the exception of zones where the strips are connected, the drain holes having a diameter preferably from 6 to 13 mm, and a total perforation area being from 3 to 25% per every 150-250 mm of a length of the strip.

16. The three-dimensional cellular structure of claim 14, being comprised of oval through holes for quick mounting with the use of a key-type fastener, the holes being located in zones of connecting the strips, having an elongated shape extending in the direction of reinforcement and being provided in the interval between the reinforcing elements.

17. The three-dimensional cellular structure of claim 14, being comprised of oval through holes for quick mounting with the use of a key-type fastener, the holes being located near end regions of the strip and extended transversely.

18. The three-dimensional cellular structure of claim 14, being comprised of oval through holes for quick mounting with the use of a key-type fastener, the holes being located near end regions of the strip and extended longitudinally.

19. The three-dimensional cellular structure of claim 14, being a spatial geogrid.
